(19) United States
(12) Patent Application Publication
(10) Pub. No.: US 2003/0211829 A1
(43) Pub. Date: Nov. 13, 2003

(54) Method and apparatus for providing substantially uninterrupted communications in a satellite network system

(76) Inventors: Michael de la Chapelle, Bellevue, WA (US); David C. Morse, Sammamish, WA (US); Leonard J. Quadracci, Seattle, WA (US)

Correspondence Address: Mark D. Elchuk, Harness, Dickey & Pierce, P.L.C., P.O. Box 828, Bloomfield Hills, MI, 48303, US

(21) Appl. No.: 10/143,693

(22) Filed: May 10, 2002

(51) Int. Cl. H04B 7/185

(52) U.S. Cl. 455/12.1; 455/446

(57) ABSTRACT

A communication management system and technique that provides a flexible yet efficient means of coordinating communications between an Earth bound user and a non-geosynchronous orbit (NGSO) satellite constellation. The system distributes the majority of the management of communications links to operations and control center and the ground based users. Therefore, the responsibility for handling communication management is performed by the ground based users and control center as opposed to being the responsibility of the NGSO satellites. This allows the NGSO satellites to be minimized in size and cost while maximizing the resources available to users. Furthermore, the ground based systems may be more easily updated and maintained than would be the case if the satellites were responsible for this task.

### FIELD OF THE INVENTION

The present invention relates to a call or communication management system between an Earth based user and a satellite system and, more particularly, to a communication management system having an Earth based control system, Earth based user, and a low Earth orbit satellite constellation.

### BACKGROUND OF THE INVENTION

Satellites have been used for years to provide communications between multiple points on the Earth's surface. Satellites may be placed into geo-synchronous or non-geo-synchronous orbit over the Earth to provide communication links between at least two areas which are covered by the satellite. The geosynchronous satellite, or at least a beam of the satellite, never moves relative to the Earth's surface, but rather remains in a fixed location relative to any given location on the ground.

Recently, the growth of commercial and civilian uses of communication satellites has required the placement of additional satellites in orbit over the Earth to provide the required communication capacity. Many of these systems use non-geosynchronous orbit (NGSO) constellations which move relative to the Earth's surface. This is to say that the beams created by the satellites sweep across the Earth's surface as the Earth rotates on its axis and the satellites orbit the Earth. Therefore, one satellite does not continuously service one particular area, but rather many satellites service one area as the beams sweep through the service area. Such systems require complex calculations regarding which satellites will be covering a particular area and what resources of the satellites are available. Also calculations are required to determine when hand-offs between one channel or one satellite beam to another must occur and when they do occur.

Often, such calculations are made as part of the workload of the satellite itself. This increases the size and payload of the satellite. Putting such calculation performing equipment and systems on the satellite also decreases the amount of mass that the satellite carries that may be dedicated to the communications equipment. In addition, the lower the orbit of the NGSO satellite the greater the computational complexity. This is because the lower the orbit of the satellite constellation, the faster the beams move relative to the surface of the earth. Therefore, the greater number of computations will need to occur per time step to ensure sufficient communication integrity with the user.

Therefore, it is desirable to provide a system which does not require the calculations for communication management to be placed on the satellite itself. Such systems, however, require that the Earth be properly mapped so that the user will know its location relative to the satellites and the satellites will be properly configured to provide resources to the user.

### SUMMARY OF THE INVENTION

The present invention relates to a communication management system and technique that provides a flexible yet efficient means of coordinating communications between a ground based user and a non-geosynchronous orbit (NGSO) satellite constellation. The present invention distributes the majority of the management responsibility to a ground based operations and control center and the ground based users. Therefore, the communication management techniques of the present invention are performed by ground based users and control center as opposed to being placed on the NGSO satellites. This allows the NGSO satellites to be minimized in size and cost while maximizing resources available to users. Furthermore, the ground based systems may be easily updated and maintained.

A first preferred embodiment of the present invention comprises a communication planning system. The communication planning system comprises at least one satellite comprising a plurality of communication resources and adapted to produce a footprint comprising at least one signal beam, wherein the signal beam is projected onto a ground surface. A transceiver is positioned on the ground surface, and is adapted to perform a communication with the satellite using at least a first one of the plurality of signal resources. The planning system also comprises a control system. The control system determines a configuration of the plurality of signal resources such that the at least one satellite allocates the at least first signal resource to the transceiver.

A second preferred embodiment of the present invention comprises a system for providing substantially uninterrupted transmissions between a terrestrial based transceiver and an orbiting satellite network. The system comprises at least one transceiver adapted to communicate with a satellite in at least one configuration. The satellite comprises a communication resource and an antenna, wherein the antenna is adapted to produce a footprint comprising at least two beams which are movable relative to the transceiver. A storage system is employed for storing a location of the transceiver. A processor allocates the communication resources among the two beams. The configuration of the transceiver corresponds to a communication resource to allow sending and receiving a data stream between the transceiver and the satellite.

The present invention comprises a preferred method to ensure that a communication is generally constant between a satellite network and a transceiver comprising an organizational unit. The method comprises providing a satellite constellation comprising at least one satellite orbiting the Earth in a non-geosynchronous orbit; providing a plurality of signal resources on the satellite; producing a footprint comprising a plurality of signal beams adapted to allow transmission of a data stream using the plurality of signal resources; and transmitting a data stream between the transceiver and the satellite by transmitting a signal along the signal beam using one of the signal resources. The method also includes determining an optimal configuration of the plurality of signal resources to ensure that the transmission is substantially continuous between the transceiver and the satellite.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagrammatic view of a communication system according to a preferred embodiment of the present invention;

FIG. 2 is a diagrammatic view of an Earth based fixed cell and its associated uplink cell;

FIG. 3 is a diagrammatic view of a plurality of uplink cells and their associated Earth based fixed cells;

FIG. 4 is an exemplary registration table for a satellite according to a preferred embodiment of the present invention; and

FIG. 5 is an exemplary registration table for total resources for each beam of a satellite.

### DETAILED DESCRIPTION OF THE PREFERRED EMBODIMENTS

The following description of the preferred embodiment(s) is merely exemplary in nature and is in no way intended to limit the invention, its application, or uses.

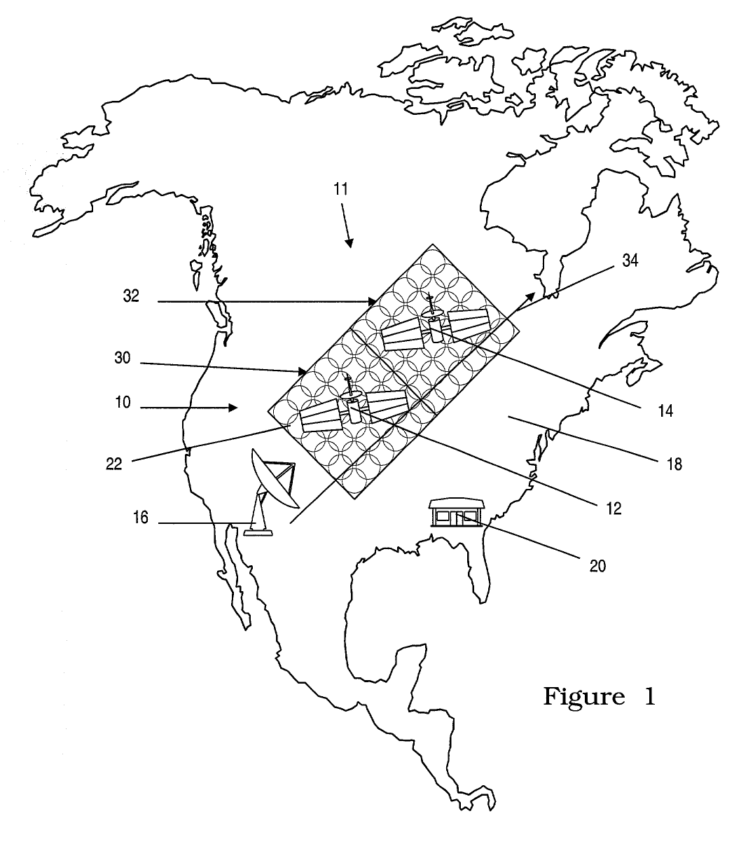

With reference to FIG. 1, a non geo-synchronous orbit (NGSO) satellite system 10 is provided to manage transmissions between a satellite constellation 11 that generally includes at least a first NGSO satellite 12 and a second NGSO satellite 14. It will be understood that the satellite constellation 11 may include any number of satellites, and only the first NGSO satellite 12 and the second NGSO satellite 14 have been illustrated to simplify the following description. It will also be understood that the following description may pertain to any surface which has in place a non-geosynchronous orbiting constellation of satellites. It will be further understood that although the following description relates to beams of the first and second NGSO satellites 12, 14 that move relative to a surface, the following description will also relate to any system where beams of a satellite move relative a surface for any other reason, such as movement of an antenna creating the beam. The NGSO system 10 also includes at least one ground based transceiver 16 which can communicate with the NGSO satellites 12,14. It will be understood that the transceiver 16 may be either stationary or mobile. If the transceiver 16 is mobile, the transceiver 16 is able to move relative to a ground surface 18. Additionally, the NGSO system 10 includes a Network Operations Control Center (NOCC) 20. The NOCC 20 is able to store historical and predicted locations of the transceiver 16 and the orbits of the NGSO satellites 12,14.

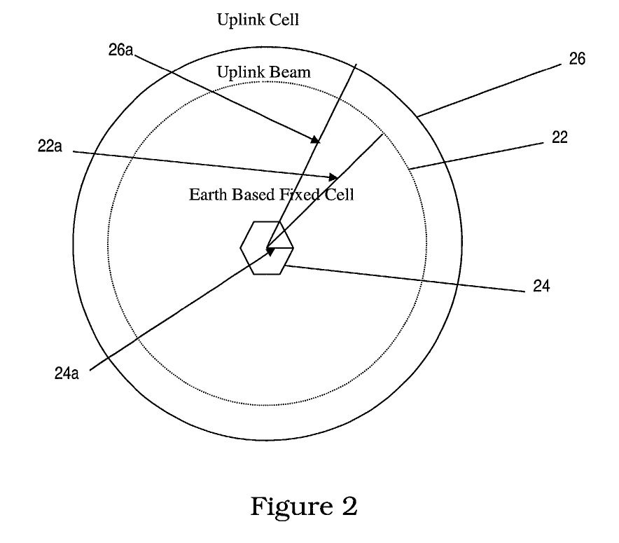

It will be understood that each attribute, feature, and system attributed to the first NGSO satellite 12 will also be incorporated with the second NGSO satellite 14 and any other satellite in the satellite constellation 11. With additional reference to FIG. 2, the first NGSO satellite 12 produces at least one uplink or communication beam 22. The uplink beam 22 has an uplink beam radius 22a which is projected from the first NGSO satellite 12 down to the ground surface 18. The uplink beam 22 engages at least one Earth fixed cell or Earth based fixed cell 24 (described more fully herein), having an Earth based fixed cell radius 24a. An uplink cell 26 has an uplink cell radius 26a defined by the uplink beam radius 22a plus the Earth based fixed cell radius 24a. Each Earth based fixed cell 24 shares a center with at least one associated uplink cell 26. Preferably, each Earth based fixed cell 24 shares a center with exactly one associated uplink cell 26. Also, as discussed below, each uplink cell 26 is associated, generally, with a plurality of Earth based fixed cells 24. Therefore, the NGSO satellite system 10 defines a plurality of uplink cells 26 and their associated Earth based fixed cells 24.

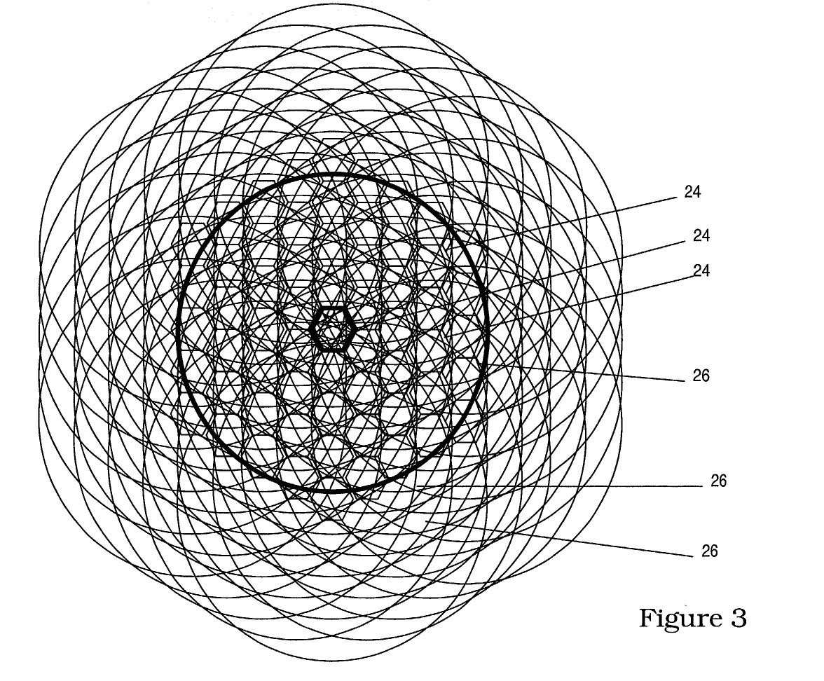

With reference to FIG. 3, a plurality of uplink cells 26 are shown which intersect at a plurality of points. At the center of each uplink cell 26 is one of the Earth based fixed cell 24. Therefore, each uplink cell 26 has exactly one Earth based fixed cell 24 which is at the center of each uplink cell 26. Additionally, each uplink cell 26 is associated with a plurality of Earth based fixed cells 24. That is, that the circumference of the uplink cell 26 is greater than the perimeter of the Earth based fixed cell 24 and, therefore, encompasses more than one Earth based fixed cell 24. Thus, the uplink cell 26 may be associated with a plurality of Earth based fixed cells 24. In addition, each Earth based fixed cell may intersect more than one uplink cell 26 due to the fact of the plurality of uplink cells 26.

The first NGSO satellite 12 produces at least one uplink beam 22 from an antenna positioned on the first NGSO satellite 12. Generally, the first NGSO satellite 12 produces more than one uplink beam 22 which, in turn, forms a first footprint or array 30 of uplink beams 22 which are projected onto the ground surface 18. It will also be understood that each uplink beam 22 may be associated with a separate antenna on the first NGSO satellite 12. Because the first NGSO satellite 12 does not have a geosynchronous orbit, the first NGSO satellite 12 constantly be moving relative to the ground surface 18. Therefore, the transceiver 16 will actually pass through a plurality of the uplink beams 22 produced by the first NGSO satellite 12 as the transceiver 16 moves through the first array 30. Furthermore, as the transceiver 16 continues to move not only will the transceiver 16 pass through a plurality of uplink beams 22 from the first array 30 produced by the first NGSO satellite 12, the transceiver 16 will also pass through a plurality of uplink beams 22 produced by the second NGSO satellite 14. Therefore, the transceiver 16, as it moves through the first array 30 and the second array 32, will define a user path 34 which intersects a plurality of uplink beams 22. The user path 34 is also defined by the orbit of the first NGSO satellite 12 about the ground surface 18.

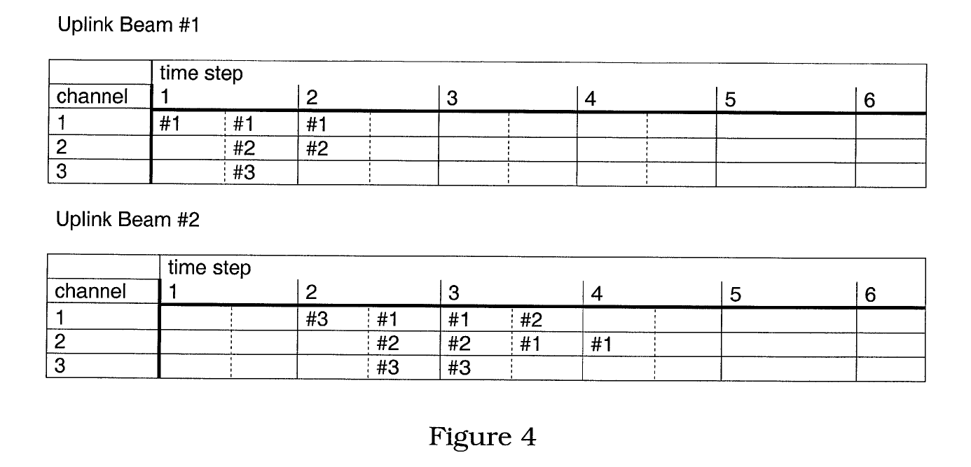

With reference to the tables illustrated in FIG. 4, each beam from the first NGSO satellite 12 has associated with it particular signal, communication, and physical resources or limitations. The tables defining the associated resources define registrations for the first NGSO satellite 12. These signal resources include different frequencies or channels the first NGSO satellite 12 may associate with or allocate to the transceiver 16. Particularly if there are a plurality of transceivers 16, decisions are made as to how to allocate the resources of the first NGSO satellite 12 to serve the transceiver 16. When the transceiver 16 initiates a communication or transmission, the transceiver 16 is allocated a particular amount of the resources available on the first NGSO satellite 12. When the transceiver 16 initiates a communication with the first NGSO satellite 12, the first NGSO satellite 12 allocates the transceiver 16 a channel in one of the beams that the transceiver 16 will cross such that the transceiver 16 will be able to communicate with the first NGSO satellite 12. As the transceiver 16 passes through the first array exiting a first uplink beam 22 and encountering other uplink beams 22, the first NGSO satellite 12 will continually change the channel that the user is allocated, if that is necessary, through a process described more fully herein. Therefore, the transceiver 16 is allocated resources and channels to ensure that the transceiver 16 is always able to communicate with the first NGSO satellite 12.

The ground surface 18 is divided into a plurality of Earth based fixed cells 24. The center of each Earth fixed cell 24 corresponds to the center of one uplink cell 26. Furthermore, each uplink cell 26 has a logical association with each Earth based fixed cell 24 within its circumference. An uplink beam 22, however, may move through a plurality of uplink cells 26 because the uplink beam 22 moves relative ground surface 18. Therefore, as the first NGSO satellite 12 moves relative to the ground surface 18, the uplink beam 22 will move relative to the uplink cells 26 defined on the ground surface 18.

On the first NGSO satellite 12 each uplink beam 22 is associated with a reservation table or registration. The reservation table includes a plurality of time steps to distinguish one moment from the next. Two such reservation tables for two uplink beams 22 are illustrated in FIG. 4 as uplink beam 1 and uplink beam 2. If there are, for example, three transceivers 16 with which the first NGSO satellite 12 will be maintaining a communication, then the first NGSO satellite 12 must allocate to each transceiver 16 a particular channel while those transceivers 16 are being serviced with one particular uplink beam 22. Therefore, an exemplary reservation table includes time steps formed as columns. Channels are denoted by rows across each of the time steps. In each of the time steps, the transceiver 16 is allocated a particular channel which it uses to communicate with the first NGSO satellite 12. As the transceiver 16 moves between beams and moves in time, the first NGSO satellite 12 will reallocate the channel given to the specific transceiver 16 to ensure that the transceiver 16 is allowed to transmit continuously with the first NGSO satellite 12. However, if the load within a particular uplink beam 22 is not heavy, then the first NGSO satellite 12 may not need to reassign different channels to the transceiver 16.

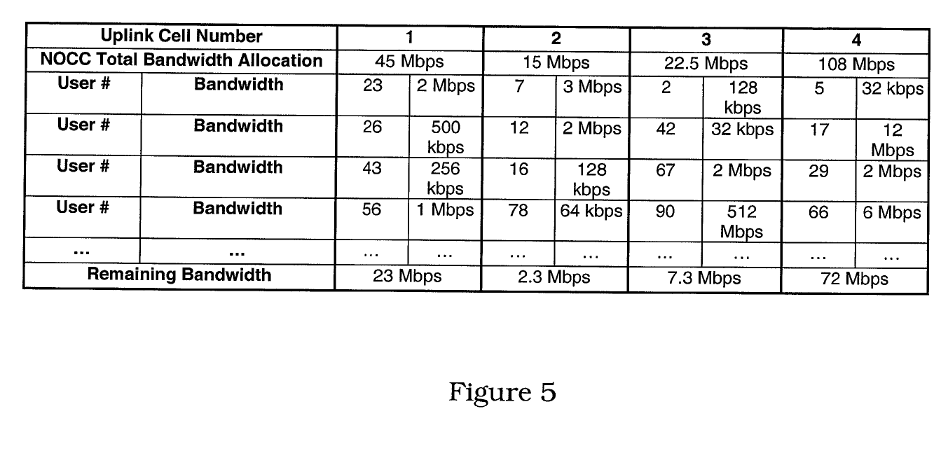

With continuing reference to FIG. 4 and further reference to FIG. 5, the NGSO satellite system 10 works to ensure that the transceiver 16 may initiate a communication with the first NGSO satellite 12 and not have that communication dropped by the NGSO satellite system 10 during the duration of the communication between the transceiver 16 and the NGSO satellite system 10. This process begins when the NOCC 20 determines a spatial and temporal distribution of communication traffic over the NGSO satellite system 10. The NOCC 20 bases this determination on historical usage information. This determination is made upon historical data of the transceivers 16 use of the NGSO satellite system 10. The NOCC 20 then determines the most efficient configuration of the first NGSO satellite 12.

The NOCC 20 may use many factors when determining how to configure registrations of the first NGSO satellite 12 to provide service to the transceiver 16. The NOCC 20 makes these configuration determinations based upon considerations such as frequency reuse limitations, array capacity of the first NGSO satellite 12, and power management. In this way, much of the configuring of the resources which will be allocated to particular transceivers 16 is computed by the ground based NOCC 20. Because the NOCC 20 is ground based, the performance capabilities of the NOCC 20 will not be limited by payload and size concerns, which affect the first NGSO satellite 12. The first NGSO satellite 12 need only carry the actual resources, such as modems and processors, for determining real time signal resource allocation to the transceiver 16.

After the NOCC 20 has determined the appropriate or total of bandwidth allocation for the first NGSO satellite 12, particularly for each uplink cell 26 through which an uplink beam 22 of the first NGSO satellite 12 may pass, this information of total bandwidth allocation is transmitted to the first NGSO satellite 12. In this way, the first NGSO satellite 12 will have a known total or maximum bandwidth allocation for each particular uplink cell 26. This will be kept in a separate registration table, particularly shown in FIG. 5, which will associate the total bandwidth allocation with each uplink cell number.

The transceiver 16, which is also an integral part of the NGSO satellite system 10, is aware of the uplink beams 22 produced by the first NGSO satellite 12 and the location of the transceiver 16 relative to the uplink beams 22 as the first NGSO satellite 12 orbits the ground surface 18. When the transceiver 16 initiates a communication with the first NGSO satellite 12, the transceiver 16 will compute a path through the first array 30 of the first NGSO satellite 12. In this manner, the transceiver 16 will know which beams the transceiver 16 will pass through during the communication between the transceiver 16 and the first NGSO satellite 12. That is, the transceiver 16 will determine its user path 34. During this communication setup phase the transceiver 16 will also request a particular bandwidth for use during the communication. This will allow the first NGSO satellite 12 to determine which channel the transceiver 16 will be allocated during the communication between the first NGSO satellite 12 and the transceiver 16. The particular channel or channels allocated are also transmitted to the transceiver 16 at this time, if the first NGSO satellite 12 determines there is enough bandwidth for the transceiver 16. The particular channel allocated will depend upon the user path 34 taken through the first array 30 of the first NGSO satellite 12.

The first NGSO satellite 12 determines whether the requested bandwidth is available in the requested uplink cell 26 that are logically associated to the user's 16 Earth based fixed cell 24. This can be done quickly by a reference to the bandwidth allocation table, illustrated in FIG. 5, which includes the total bandwidth allocation for each particular uplink cell 26 along with a particular transceiver 16 and the reserved bandwidth for that transceiver 16. Additionally, remaining bandwidth is already known for each uplink cell 26. Therefore, the first NGSO satellite 12 is able to quickly determine whether the requested bandwidth is available. If an appropriate amount of bandwidth is not available for the transceiver 16, then the communication may not be initiated. This assures that substantially no communications accepted by the first NGSO satellite 12 will be dropped.

If the user path 34 will take it through the second array 32 of the second NGSO satellite 14, then reservations are made in the reservation tables of the second NGSO satellite 14 before the transceiver 16 enters the second array 32. Again, this ensures that proper resources are allocated for each transceiver 16 to ensure that a communication between the transceiver 16 and the NGSO satellite system 10 is not interrupted.

The signal resources on the first NGSO satellite 12 are known by the first NGSO satellite 12, which may assign different resources to a particular transceiver 16. In one preferred embodiment, each uplink beam 22 of the first NGSO satellite 12 is divided into different channels, as illustrated in FIG. 4. Therefore, each uplink beam 22 that the first NGSO satellite 12 produces includes a number of channels depending upon the band width necessary for the transceivers 16. The channels are divided into time increments or time steps so that they may be assigned for any particular time step to a transceiver 16. Therefore, the first NGSO satellite 12 will determine which channels the transceiver 16 will be allocated and then assign to the transceiver 16 the allocated channels for the time increments which the transceiver 16 will pass through any particular uplink beam 22. As an illustration, if a transceiver 16 initiates a communication at a first time step, the satellite could assign to the transceiver 16 channel 1 at time step 1. The first NGSO satellite 12 would also assign to the transceiver 16 other channels for each of the time steps that the transceiver 16 would be intersecting that uplink beam 22. The first NGSO satellite 12 will also assign to the transceiver 16 any other channels for other time steps for the entire time the transceiver 16 will be within the first array 30.

The channels are associated with particular uplink beams 22 depending upon the configuration determined by the NOCC 20. This preconfiguring by the NOCC 20 of the resources helps make more reliable the communication between the transceiver 16 and the first NGSO satellite 12. Furthermore, the allocation of channels to particular uplink beams 22 which will intersect varying number of transceivers 16 ensures that enough channels are available so that each transceiver 16 will be able to communicate with the first NGSO satellite 12. When the transceiver 16 initiates a communication with the first NGSO satellite 12, it communicates to the first NGSO satellite 12 the user path 34. The first NGSO satellite 12 will then reserve channels, bandwidth, and associated time steps to be used by the transceiver 16 after assuring there is enough bandwidth available for the transceiver 16 by reference to the total bandwidth allocation table. Reservations for the transceiver 16 during its entire time within the first array 30 are made during the initial communication setup. The channels and other information relating to a particular transceiver 16 is known as state information.

As the first NGSO satellite 12 orbits the Earth, the uplink beam 22 produced by the first NGSO satellite 12 moves in and out of particular uplink cells 26. Therefore, as the first array 30 moves past the uplink cell 26, which includes the transceiver 16, the first NGSO satellite 12 will no longer need to retain the state information for the transceiver 16. As the transceiver 16 leaves the first array 30, the first NGSO satellite 12 transmits state information of the transceiver 16 to the second NGSO satellite 14 before the transceiver 16 enters the second array 32. Therefore, the state information related to the transceiver 16 is only stored by the NGSO satellite 12, 14 with which the transceiver 16 is currently communicating. Thus, resources are not used to store information for transceivers 16 for which the first NGSO satellite 12 is not providing a channel.

All channel reservations, or the state transmission, for the transceiver 16 are transferred for user path 34 through the entire first array 30 is transmitted to the transceiver 16 at one time. Therefore, a single transmission from the transceiver 16 to the first NGSO satellite 12 prepares for the transceiver 16 all of the channels the transceiver 16 will be using during the time the transceiver 16 is within the first array 30. This reduces the times which information may be lost by eliminating subsequent state transmissions between the transceiver 16 and the first NGSO satellite 12. Also, all of the resources of the first NGSO satellite 12, and particularly the channels assigned to different users, are known for the first NGSO satellite 12 at all times. In this way, a new user may be blocked or denied making a communication, rather than dropping a current user to ensure that each user which currently has a link with the first NGSO satellite 12 does not lose that link.

An additional advantage of a single state transmission is that a great deal of transmission bandwidth is allowed for other uses. In particular, since only one transmission is used to reserve channels on the first NGSO satellite 12, further transmissions and bandwidth is not consumed by continuously retransmitting state information between the transceiver 16 and the first NGSO satellite 12. This will allow the overhead resources dedicated to such state information to be between about 0.5% and about 0.001%. The single transmission indicates to the transceiver 16 which channel or configuration the first NGSO satellite 12 will require the transceiver 16 to use for each time step.

A communication drop rate between a transceiver 16 and the first NGSO satellite 12 should be less than about 1%. A communication drop is when the transmissions between the transceiver 16 and the first NGSO satellite 12 are interrupted for any reason. Preferably, the communication drop rate should be between about 0.5% and about 0.01%. Due to the NGSO satellite system 10, communications between the transceiver 16 and the first NGSO satellite 12 can be maintained to assure that the communication drop rate is less than about 0.5%. It will be understood, however, that if there is additional or remaining bandwidth which is not currently reserved, a higher drop rate may be allowed for users that do not require such a low drop rate. Therefore, a transceiver 16, not requiring such a low drop communication rate, may be given remaining bandwidth with the understanding that the transceiver 16, which does not require such a low communication drop rate, may be dropped to give that bandwidth to a transceiver 16 which does require a low communication drop rate.

Additionally, since the transceiver 16 will be transferred between the first NGSO satellite 12 and the second NGSO satellite 14, the state information of the transceiver 16 and reservations for the transceiver 16 must also be transmitted to the second NGSO satellite 14. Because the user is already aware of which cells it will pass through, that information is transferred to the second NGSO satellite 14 far in advance of the actual hand over of the transceiver 16 transmission from the first NGSO satellite 12 to the second NGSO satellite 14. In particular, this hand over information may be transferred from the first NGSO satellite 12 to the second NGSO satellite 14 at any time.

Preferably the state transfer is done when the transceiver 16 is one-half of the distance through the first array 30, then the transceiver 16 is closest to the first NGSO satellite 12 and there is ample time to retransmit the state information if it is lost. The physical closeness of the transceiver 16 to the first NGSO satellite 12 reduces the possibilities of scattering and absorption of the atmosphere. Therefore, the user path 34 is transmitted to the second NGSO satellite 14 long before the transceiver 16 enters the second array 32.

As soon as the user path 34 is known the second NGSO satellite 14 may reserve channels for the transceiver 16 and transmit those to the transceiver 16. Although state information may be transferred inter-satellite it will also be understood that state information may be transferred from a ground based unit. That is either the transceiver 16 or other ground based communication centers, such as the NOCC 20. Therefore, the state transmission need not occur directly between the first NGSO satellite 12 and the second NGSO satellite 14.

The NOCC 20 predetermines the satellite configurations such that the NOCC 20 knows the maximum capacity each satellite may handle without dropping a communication initiated by a transceiver 16. The NOCC 20 has determined this maximum capacity for each uplink cell 26. The transceiver 16 is aware of its Earth based fixed cell 24 and uplink cell 26, which is also known by the NOCC 20 for each transceiver 16. Therefore, the first NGSO satellite 12 will be able to provide the appropriate channel and bandwidth to the particular transceiver 16 so that the capacity of the uplink beam or beams 22 is not overloaded for the particular uplink cell 26. In this way, the first NGSO satellite 12 can ensure that the maximum capacity computed by the NOCC 20 is never exceeded by the transceivers 16 that pass through the first array 30 of the first NGSO satellite 12.

The efficiency of the NGSO satellite system 10 approaches 100% when the uplink beam 22 is the same size as the uplink cell 26. However, as uplink beam radius 22a approaches the uplink cell radius 26a, the computational complexity of the NGSO system 10 increases to allow for providing enough resources to ensure that an overload does not occur in the NGSO system 10. This is so because decreasing the uplink cell radius 26a relative to the uplink beam radius 22a decreases the size of the Earth based fixed cell radius 24a and increases the number of time steps for the reservation tables. The number of computations that must occur to transfer the transceiver 16 between the different channels or resources on the first NGSO satellite 12 become nearly infinite. However, since the NOCC 20 has determined the optimal configuration for each uplink cell 26, and has determined where the heaviest usage may occur, the first NGSO satellite 12 configurations may be selected so that there are enough resources and computational capacity for the heaviest usage areas while allowing areas of lesser usage to be allocated less resources and computational capacity.

Because of the configuration computations performed by the NOCC 20 and the knowledge of user paths 34 by the transceiver 16, the only computational aspects required of the first NGSO satellite 12 are those relating to the reservation and resource allocation tables. All of the other computational work regarding communication management is performed by the NOCC 20. This ensures that the first NGSO satellite 12 is aware of the maximum amount of bandwidth which is available in each uplink beam 22. This also reduces the number of dropped communications in the NGSO satellite system 10. Also, since the NOCC 20 and transceiver 16 are ground based components, they may be easily upgraded. Moreover, the payload of the first NGSO satellite 12 is greatly diminished due to the placement of much of the computational activity on the NOCC 20. Because of this, the first NGSO satellite 12 become easier to manufacture and place in orbit. Also, the NOCC 20 determines the maximum load which is offered by transceiver 16 and ensures that the first NGSO satellite 12 is configured so that all of the transceivers 16 have access to a channel of the first NGSO satellite 12.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A communication planning system, comprising:
at least one satellite comprising a plurality of communication resources and adapted to produce a footprint comprising at least one signal beam, wherein said at least one signal beam is projected onto a ground surface;
a transceiver for communicating with said at least one satellite using at least a first of said plurality of communication resources; and
a control system, for determining a configuration of said plurality of communication resources such that said at least one satellite allocates said at least first communication resource to said transceiver.

2. The communication planning system of claim 1,
wherein said at least one signal beam comprises a plurality of signal beams; and
wherein each of said plurality of signal beams comprises said plurality of communication resources.

3. The communication planning system of claim 4,
wherein said control system configures said plurality of signal resources before said transceiver initiates said communication with a first satellite of said plurality of satellites, such that said first satellite is apprised of a maximum capacity for each of said plurality of signal beams.

4. The communication planning system of claim 1, wherein said at least one satellite comprises a plurality of satellites.

5. The communication planning system of claim 1, wherein said plurality of signal resources comprises a communications channel within said at least one signal beam.

6. The communication planning system of claim 1, wherein said at least one signal resource of said plurality of signal resources is allocated by said at least one satellite when said transceiver initiates said communication with said at least one satellite.

7. The communication planning system of claim 1, wherein said transceiver is adapted to synchronously switch in real time with said at least one satellite between at least two of said plurality of signal resources.

8. The communication planning system of claim 1, wherein said at least one satellite comprises at least a first satellite and a second satellite, wherein said transceiver is allocated at least one signal resource of said second satellite while said transceiver is communicating with said first satellite.

9. The communication system of claim 8, wherein said transceiver transmits to said first satellite a path of said transceiver through said footprint of said second satellite, and wherein said first satellite transmits said path to said second satellite.

10. A method to ensure that a communication is generally constant between a satellite constellation and a transceiver comprising an organizational unit, the method comprising:
providing a satellite constellation comprising at least one satellite orbiting the Earth in a non-geosynchronous orbit;
providing a plurality of signal resources on said at least one satellite;
producing a footprint comprising a plurality of signal beams adapted to allow transmission of a data stream using said plurality of signal resources;
transmitting a data stream between the transceiver and said at least one satellite by transmitting a signal along said signal beam using one of said signal resources; and
determining an optimal configuration of said plurality of signal resources to ensure that said data stream is substantially continuous between said transceiver and said at least one satellite.

11. The method of claim 10, further comprising:
configuring a registration comprising a look up table for each of said plurality of signal beams to include at least one of said plurality of signal resources based upon said optimal configuration.

12. The method of claim 11, wherein said step of communicating between said transceiver and said satellite, comprises:
transmitting from said transceiver to said at least one satellite a location of said transceiver;
transmitting to said at least one satellite from said transceiver through which of said plurality of said signal beams said transceiver will pass; and
receiving and transmitting a data stream between said transceiver and said at least one satellite as said transceiver passes through said footprint.

13. The method of claim 12, further comprising:
reserving at least one of said plurality of signal resources in said registration;
transmitting to said transceiver said reserved signal resource; and
setting said transceiver to send and receive a data stream using said reserved signal resource.

14. The method of claim 10, wherein the step of determining an optimal configuration, comprises:
determining a location of said transceiver;
determining a location of an uplink cell, wherein said location of the transceiver is relative said location of said uplink cell;
predicting a future usage of said transceiver; and
determining said optimum distribution of said plurality of signal resources for said uplink cell based upon said predicted usage patterns.

15. The method of claim 10,
wherein the step of providing a satellite constellation comprising at least one satellite comprises providing at least a first satellite and a second satellite, wherein said first satellite produces a first footprint and said second satellite produces a second footprint;
transmitting to said first satellite from said transceiver a path of said transceiver through said second footprint;
transmitting to said second satellite from said first satellite said path of said transceiver through said second footprint; and
reserving on said second satellite signal resources in said path for said transceiver.

16. A system for providing substantially uninterrupted communications between a terrestrial based transceiver and an orbiting satellite network, comprising:
at least one transceiver adapted to communicate with a satellite in at least one configuration;
at least one satellite adapted to communicate with said transceiver, wherein said satellite comprises a communication resource and an antenna, wherein said antenna is adapted to produce a footprint comprising at least two beams which are movable relative to said transceiver;
a storage system for storing a location of said transceiver;
a processor, for allocating said communication resources among said two beams; and
wherein said configuration of said transceiver corresponds to said communication resource to allow sending and receiving a data stream between said transceiver and said satellite.

17. The system of claim 16,
wherein said transceiver comprises a plurality of transceivers each having a discrete location; and
wherein said storage system stores the locations of each of said plurality of transceivers.

18. The system of claim 16,
wherein said two beams comprise a first beam and a second beam; and
wherein said transceiver transmits to said satellite to inform said satellite when said transceiver will pass from said first beam to said second beam.

19. The system of claim 16,
wherein said satellite comprises at least a first satellite and a second satellite, wherein said first satellite produces a first footprint and said second satellite produces a second footprint;
wherein said transceiver transmits to said first satellite a time and a path through which said transceiver will pass through said first footprint; and
wherein said transceiver transmits to said first satellite a time and a path through which said transceiver will pass from said first footprint to said second footprint and a time and a path through which said transceiver will pass through said second footprint; and
wherein said first satellite transmits to said second satellite said time and said path said transceiver will pass from said second footprint.
